(19) United States
(12) Patent Application Publication
(10) Pub. No.: US 2013/0198758 A1
(43) Pub. Date: Aug. 1, 2013

(54) TASK DISTRIBUTION METHOD AND APPARATUS FOR MULTI-CORE SYSTEM

(71) Applicant: ELECTRONICS AND TELECOMMUNICATIONS RESEARCH INSTITUTE, Daejeon-city (KR)

(72) Inventors: Dong-Hyouk LIM, Daejeon (KR); Yung-Joon JUNG, Daejeon (KR); Dong-Hwan SON, Daejeon (KR); Chae-Deok LIM, Daejeon (KR)

(73) Assignee: ELECTRONICS AND TELECOMMUNICATIONS RESEARCH INSTITUTE, Daejeon-city (KR)

(21) Appl. No.: 13/753,642

(22) Filed: Jan. 30, 2013

(30) Foreign Application Priority Data
Jan. 31, 2012 (KR) 10-2012-0009789

(51) Int. Cl. G06F 9/50

(52) U.S. Cl. CPC G06F 9/5038
USPC 718/104

(57) ABSTRACT

The present invention relates generally to a task distribution method and apparatus for systems in a real-time Operating System (OS) environment using a multi-core Central Processing Unit (CPU). The present invention is configured to set roles of multiple cores included in the multi-core system in such a way as to divide the cores into real-time cores for executing real-time tasks and non-real-time cores for executing non-real-time tasks, allocate real-time tasks to cores, a role of which has been set to that of real-time cores, and non-real-time tasks to cores, a role of which has been set to that of non-real-time cores, based on the set roles of the cores, allow the respective cores to execute the tasks allocated thereto, and collect information about a procedure of executing the tasks as task execution procedure information, and change the set roles of the cores based on the collected information.

### CROSS REFERENCE TO RELATED APPLICATION

This application claims the benefit of Korean Patent Application No. 10-2012-0009789, filed on Jan. 31, 2012, which is hereby incorporated by reference in its entirety into this application.

### BACKGROUND OF THE INVENTION

1. Technical Field

The present invention relates generally to a task distribution method and apparatus for systems in a real-time Operating System (OS) environment using a multi-core Central Processing Unit (CPU).

2. Description of the Related Art

With the development of recent CPU manufacturing technology, the core systems of most current computers have rapidly changed to multi-core systems, each having two or more cores. The Operating System (OS) of such a multi-core system has developed from an existing single core-based form into a form supporting multiple cores so as to efficiently operate two or more cores.

The important part of a multi-core system is related to its performance, and the performance of the entire system is influenced by how many cores can be simultaneously utilized. Therefore, the method used to efficiently allocate multiple tasks has a great influence on the performance of the system. That is, the utilization of multiple cores by a scheduler has become a factor that affects the performance of the system.

Existing Operating Systems (OSs) widely handled scheduling in a multi-processor environment before a multi-core environment is used. As the system has developed into a multi-core system with integrated caches, OSs have efficiently performed scheduling by improving a plurality of schedulers. Further, most OSs including Windows and Linux are currently equipped with schedulers that support a multi-processor environment and a multi-core environment.

However, such a scheduler has been developed assuming a performance-centered system as the OS of a general-purpose system, and does not correspond to a real-time system.

In particular, there is a problem in that when a system which is executing real-time tasks and non-real-time tasks together uses the existing scheduler without changing it, the processing speed of the real-time tasks decreases due to the non-real-time tasks.

Further, technology related to the task distribution of a multi-core system (disclosed in Korean Unexamined Patent Application Publication No. 2009-0066765 and entitled “Method and apparatus for moving tasks in core platform”) has been presented, but is problematic in that it is difficult to efficiently set the roles of cores and distribute tasks.

Therefore, there is a need to incorporate the characteristics of a real-time system in a multi-core system, so that the real-time system must be operated to be capable of accurately executing real-time tasks and minimizing the deterioration in the performance of non-real-time tasks. That is, the initial distribution and exchange of tasks in the multi-core system must be efficiently performed.

### SUMMARY OF THE INVENTION

Accordingly, the present invention has been made keeping in mind the above problems occurring in the prior art, and an object of the present invention is to provide a task distribution method and apparatus, which can distribute real-time tasks and non-real-time tasks to the cores of a system by incorporating the characteristics of the real-time tasks in the system and can dynamically solve imbalances occurring during the execution of the tasks.

In accordance with an aspect of the present invention to accomplish the above object, there is provided a task distribution method for a multi-core system, including setting roles of multiple cores included in the multi-core system in such a way as to divide the cores into real-time cores for executing real-time tasks and non-real-time cores for executing non-real-time tasks, allocating real-time tasks to cores, a role of which has been set to that of real-time cores, and allocating non-real-time tasks to cores, a role of which has been set to that of non-real-time cores, based on the set roles of the cores, allowing the respective cores to execute the tasks allocated thereto, and collecting information about a procedure of executing the tasks as task execution procedure information, and adjusting the set roles of the cores based on the collected information.

In accordance with another aspect of the present invention to accomplish the above object, there is provided a task distribution apparatus for a multi-core system, including a multi-core unit including multiple cores for executing tasks, an execution information collection unit for collecting task execution information while tasks allocated to the multiple cores are being executed by the multiple cores, a core role setting unit for setting roles of the multiple cores included in the multi-core unit in such a way as to divide the cores into real-time cores for executing real-time tasks and non-real-time cores for executing non-real-time tasks, and adjusting the set roles of the cores based on the task execution information, and a task allocation unit for allocating real-time tasks to cores, a role of which has been set to that of real-time cores, and allocating non-real-time tasks to cores, a role of which has been set to that of non-real-time cores, based on the set roles of the cores.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a flowchart showing a task distribution method according to an embodiment of the present invention;

FIG. 2 is a flowchart showing in detail the core role setting step of FIG. 1;

FIG. 3 is a flowchart showing in detail the task allocation step of FIG. 1;

FIG. 4 is a flowchart showing in detail the task execution step and the task execution result feedback step of FIG. 1; and

FIG. 5 is a block diagram showing the configuration of a task distribution apparatus for a multi-core system according to an embodiment of the present invention.

### DESCRIPTION OF THE PREFERRED EMBODIMENTS

Hereinafter, various embodiments of the present invention will be described in detail with reference to the attached drawings Further, the terms “unit,” “module,” and “device” related to components used in the following description are merely assigned for the sake of the simplicity of description of the present specification and may be used together and designed using hardware or software.

Further, embodiments of the present invention will be described in detail with reference to the attached drawings and the content described in the attached drawings, but the present invention is not limited or restricted by the embodiments.

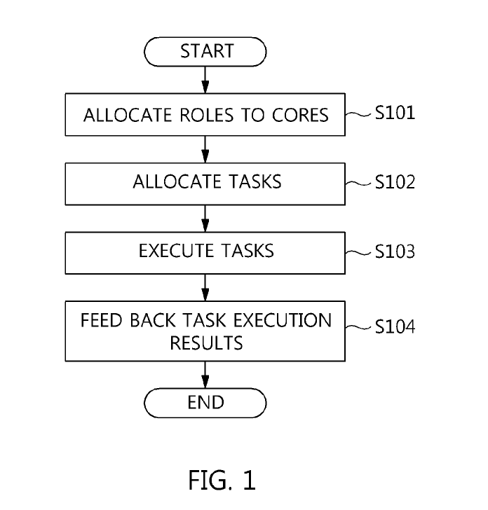

FIG. 1 is a flowchart showing a task distribution method according to an embodiment of the present invention.

In accordance with the present embodiment, a multi-core system including multiple cores may set each core to a real-time core or a non-real-time core based on task execution information.

That is, in order to improve the reactivity and punctuality of real-time tasks, the roles of cores are primarily divided into the roles of real-time cores and the roles of non-real-time cores before tasks are allocated, wherein only real-time tasks are allocated to the real-time cores, and only non-real-time tasks are allocated to the non-real-time cores. Detailed steps will be described as follows.

First, the roles of cores are allocated to the multiple cores included in the multi-core system at step S101. That is, the roles of the cores are set in such a way that the multiple cores are divided into real-time cores for executing real-time tasks and non-real-time cores for executing non-real-time tasks.

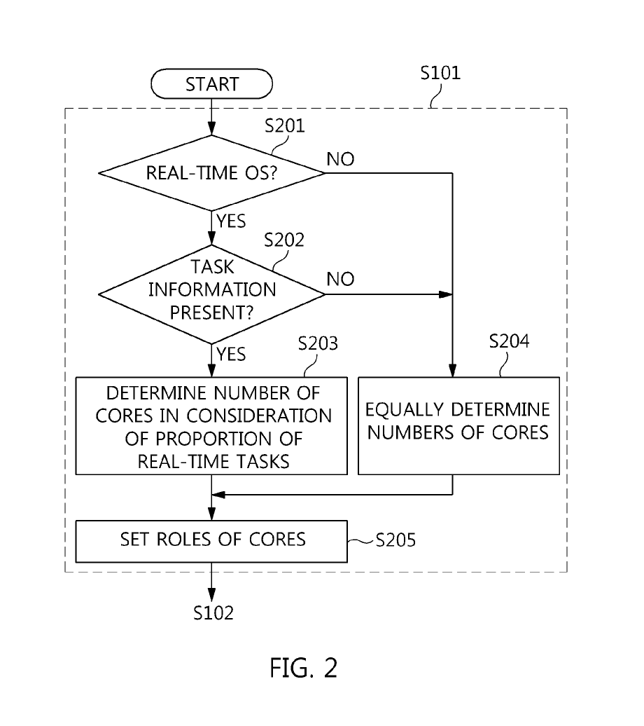

Further, in accordance with the embodiment, the number of real-time cores and the number of non-real-time cores can be set based on the task execution information. This operation will be described in detail later with reference to FIG. 2.

Next, tasks are allocated to the cores, to which the roles have been allocated, at step S102.

In accordance with an embodiment, the real-time tasks can be allocated to cores, the role of which has been set to that of real-time cores, and the non-real-time tasks can be allocated to cores, the role of which has been set to that of non-real-time cores, based on the set roles of the cores.

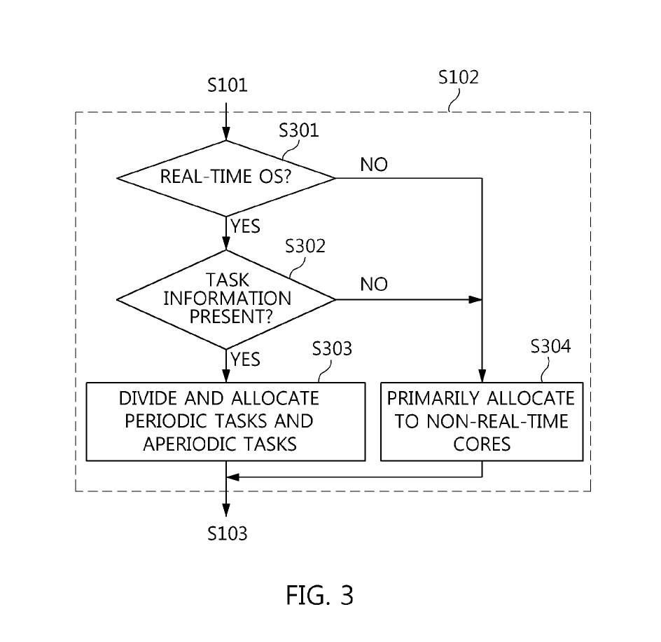

Further, in accordance with another embodiment, tasks can be allocated to respective cores with reference to the task execution information. This operation will be described in detail later with reference to FIG. 3.

Next, the respective cores execute the tasks allocated thereto at step S103.

Further, while the tasks are being executed, pieces of information about the procedure of executing the corresponding tasks (task execution procedure information) are collected, and the set roles of the cores are changed based on the collected information at step S104.

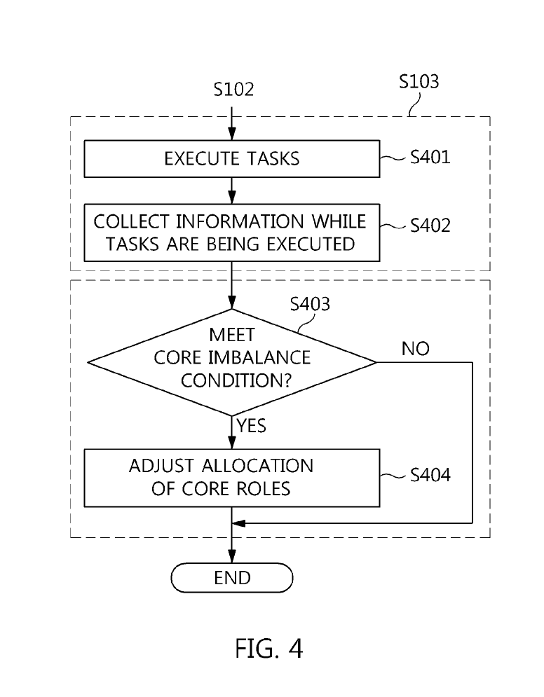

That is, in accordance with the embodiment, the number of real-time cores and the number of non-real-time cores can be changed. This operation will be described in detail later with reference to FIG. 4.

FIG. 2 is a flowchart showing in detail the core role setting step of FIG. 1.

In accordance with an embodiment, in the case where the roles of cores are set, if the OS of the multi-core system is a real-time OS at step S201, and task information about tasks to be executed by the multi-core system is present at step S202, the number of real-time cores and the number of non-real-time cores are determined such that they are proportional to the number of real-time tasks and the number of non-real-time tasks, respectively, wherein the real-time and non-real-time tasks are to be executed by the multi-core system, at step S203. Then the roles of the cores can be set at step S205.

That is, for example, when both the number of tasks scheduled to be executed by a real-time OS and the number of non-real-time tasks are known, if it is assumed that the number of multiple cores is N, the number of real-time tasks is Pᵣₜ, the number of non-real-time tasks is Pₙₒᵣₘ, the number of real-time cores is Cᵣₜ, and the number of non-real-time cores is Cₙₒᵣₘ, the number of cores can be determined by the following Equations (1) and (2):

Cᵣₜ=floor(N×Pᵣₜ÷(Pᵣₜ+Pₙₒᵣₘ)) (1)

Cₙₒᵣₘ=N−Cᵣₜ (2)

Further, if the OS is not a real-time OS or if the task information is not present, the roles of the cores can be set so that the number of real-time cores is equal to the number of non-real-time cores at steps S204 and S205.

FIG. 3 is a flowchart showing in detail the task allocation step of FIG. 1.

In accordance with an embodiment, when tasks are allocated to respective cores, it is determined whether the OS of the multi-core system is a real-time OS at step S301. If it is determined that the OS is the real-time OS, it is determined whether task information about tasks to be executed by the multi-core system is present at step S302. If the task information is present, the real-time tasks can be allocated to cores, the role of which has been set to that of real-time cores, and the non-real-time tasks can be allocated to cores, the role of which has been set to that of non-real-time cores, at step S303.

In contrast, if the OS is not a real-time OS, or if task information is not present, tasks can be primarily allocated to non-real-time cores at step S304.

That is, if the OS is a non-real-time OS, the generation and execution of tasks can be done freely, so that upon generating tasks without having preset allocation values, the tasks are initially primarily allocated to non-real-time cores. If the OS is a real-time OS, periodic tasks that are real-time tasks can be allocated to real-time cores, and a periodic tasks that are non-real-time tasks can be allocated to non-real-time cores.

FIG. 4 is a flowchart showing in detail the task execution step and the task execution result feedback step of FIG. 1.

In accordance with an embodiment, while tasks are being executed by respective cores at step S401, task execution procedure information, which includes at least one of information about task execution times, information about the number and attributes of tasks being executed, information about context switching, and information about cache misses, is collected at step S402. It is determined whether the collected information meets a preset core imbalance condition at step S403. If the collected information meets the preset core imbalance condition, the set roles of the cores can be adjusted based on the collected information at step S404.

The task execution time information may include information about a time at which a relevant core enters a sleep or block mode, information about a difference between a requested time for which a relevant task is to be executed and the actual time required for execution, information about a time at which periodic tasks are executed, and the information about a time at which a current task is executed.

Further, the cache miss information may include data loss information related to the L2 cache of the cores.

In accordance with an embodiment, when the set roles of the cores are changed, if a difference between the requested task processing time and the actual task processing time falls outside a predetermined range, based on the task execution time information, the role of a predetermined number of non-real-time cores can be reset to that of real-time cores depending on the time difference.

Further, in accordance with another embodiment, if a difference between the ratio of non-real-time tasks to real-time tasks that are executed and the ratio of non-real-time cores to real-time cores, the roles of which have been set, falls outside a predetermined range, the roles of cores can be reset such that the difference between the ratios is reduced.

Furthermore, in accordance with a further embodiment, if the occurrence of context switching increases to above a predetermined range, or if the occurrence of cache misses increases to above a predetermined range, the role of a predetermined number of real-time cores can be reset to that of non-real-time cores.

That is, the above procedure is performed at regular periods, so that imbalances between the cores can be solved. Further, when the characteristics of cores have changed, migration of the corresponding process can also be performed accordingly.

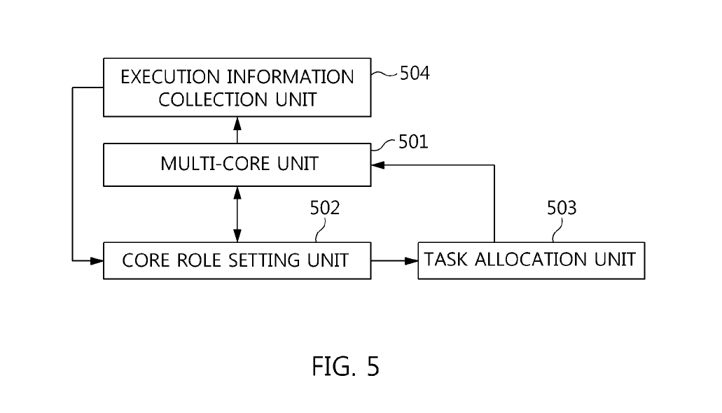

FIG. 5 is a block diagram showing the configuration of a task distribution apparatus for a multi-core system according to an embodiment of the present invention.

In accordance with the embodiment, the task distribution apparatus for the multi-core system may include a multi-core unit 501, an execution information collection unit 504, a core role setting unit 502, and a task allocation unit 503. The multi-core unit 501 includes multiple cores for executing tasks. The execution information collection unit 504 collects pieces of task execution information while tasks allocated to the multiple cores are being executed by the multiple cores. The core role setting unit 502 sets the roles of the multiple cores included in the multi-core unit in such a way as to divide the multiple cores into real-time cores for executing real-time tasks and non-real-time cores for executing non-real-time tasks, and changes the set roles of the cores based on the task execution information. The task allocation unit 503 allocates real-time tasks to cores, the role of which has been set to that of real-time cores, and allocates non-real-time tasks to cores, the role of which has been set to that of non-real-time cores, based on the set roles of the cores.

Further, in accordance with the embodiment, the execution information collection unit 504 may collect task execution procedure information which includes at least one of information about task execution times, information about the number and attributes of tasks being executed, information about context switching, and information about cache misses. The core role setting unit 502 may reset the set roles of cores based on the collected information if the collected information meets a preset core imbalance condition.

In particular, if a difference between the requested task processing time and the actual task processing time falls outside a predetermined range based on the task execution time information, the core role setting unit 502 may reset the role of a predetermined number of non-real-time cores as that of real-time cores depending on the difference between the times.

Further, if a difference between the ratio of non-real-time tasks to real-time tasks that are executed and the ratio of non-real-time cores to real-time cores, the roles of which have been set, falls outside a predetermined range, the core role setting unit 502 may reset the roles of cores such that the difference between the ratios is reduced.

Furthermore, if the occurrence of context switching increases to above a predetermined range, or if the occurrence of cache misses increases to above a predetermined range, the core role setting unit 502 may set the role of a predetermined number of real-time cores to that of non-real-time cores.

Furthermore, if the OS of the multi-core system is a real-time OS, and task information about tasks to be executed by the multi-core system is present, the core role setting unit 502 may determine the number of real-time cores and the number of non-real-time cores so that they are proportional to the number of real-time tasks and the number of non-real-time tasks, respectively, wherein the real-time and non-real-time tasks are to be executed by the multi-core system, and may set the roles of the cores of the multi-core system to those of real-time cores and non-real-time cores based on the determined numbers of the cores. In contrast, if the OS is not a real-time OS, or if the task information is not present, the core role setting unit can set the roles of cores so that the number of real-time cores is equal to the number of non-real-time cores.

Furthermore, if the OS of the multi-core system is a real-time OS, and the task information about tasks to be executed by the multi-core system is present, the core role setting unit may allocate the real-time tasks to cores, the role of which has been set to that of real-time cores, and may allocate the non-real-time tasks to cores, the role of which has been set to that of non-real-time cores. In contrast, if the OS is not a real-time OS, or if the task information is not present, the core role setting unit may primarily allocate tasks to the non-real-time cores.

As described above, when tasks are allocated to multiple cores and are changed in accordance with the configuration of the present invention, the drop in the reactivity and the problem of responsiveness caused by an existing performance-centered task scheduling algorithm can be solved, and thus efficiency can be improved. That is, multiple cores can be more suitably utilized by a real-time system.

Although the preferred embodiments of the present invention have been disclosed for illustrative purposes, those skilled in the art will appreciate that the present invention is not limited by the above-described specific embodiments and various modifications are possible, without departing from the scope and spirit of the invention as disclosed in the accompanying claims. These modifications should not be understood separately from the technical spirit or prospect of the present invention.

What is claimed is:

1. A task distribution method for a multi-core system, comprising:
setting roles of multiple cores included in the multi-core system in such a way as to divide the cores into real-time cores for executing real-time tasks and non-real-time cores for executing non-real-time tasks;
allocating real-time tasks to cores, a role of which has been set to that of real-time cores, and allocating non-real-time tasks to cores, a role of which has been set to that of non-real-time cores, based on the set roles of the cores;
allowing the respective cores to execute the tasks allocated thereto; and
collecting information about a procedure of executing the tasks as task execution procedure information, and adjusting the set roles of the cores based on the collected information.

2. The task distribution method of claim 1, wherein the adjusting the set roles of the cores comprises:
collecting task execution procedure information including at least one of information about task execution times, information about a number and attributes of tasks that are executed, information about context switching, and information about cache misses; and
if the collected information meets a preset core imbalance condition, changing the set roles of the cores based on the collected information.

3. The task distribution method of claim 2, wherein the adjusting the set roles of the cores comprises:
if a difference between a requested task processing time and an actual task processing time falls outside a predetermined range based on the task execution time information, changing a role of a predetermined number of non-real-time cores to that of real-time cores depending on the difference between the times.

4. The task distribution method of claim 2, wherein the adjusting the set roles of the cores comprises:
if a difference between a ratio of non-real-time tasks to real-time tasks that are executed and a ratio of non-real-time cores to real-time cores, the roles of which have been set, falls outside a predetermined range, resetting the roles of the cores so that the difference between the ratios is reduced.

5. The task distribution method of claim 2, wherein the adjusting the set roles of the cores comprises:
if occurrence of the context switching increases to above a predetermined range, or if occurrence of the cache misses increases to above a predetermined range, changing a role of a predetermined number of real-time cores to that of non-real-time cores.

6. The task distribution method of claim 1, wherein the setting the roles of the multiple cores comprises:
determining whether an Operating System (OS) of the multi-core system is a real-time OS;
if the OS is the real-time OS, determining whether task information about tasks to be executed by the multi-core system is present;
if the task information is present, determining a number of real-time cores and a number of non-real-time cores so that the numbers are proportional to a number of real-time tasks and a number of non-real-time tasks, respectively, wherein the real-time and non-real-time tasks are to be executed by the multi-core system; and
setting roles of the cores of the multi-core system to a role of real-time cores and a role of non-real-time cores based on the determined numbers of the cores.

7. The task distribution method of claim 6, wherein the setting the roles of the cores further comprises:
if the OS is not the real-time OS, or if the task information is not present, setting the roles of the cores so that a number of real-time cores is equal to a number of non-real-time cores.

8. The task distribution method of claim 1, wherein the allocating the tasks to the set cores comprises:
determining whether an OS of the multi-core system is a real-time OS; and
if the OS is the real-time OS, determining whether task information about tasks to be executed by the multi-core system is present; and
if the task information is present, allocating the real-time tasks to cores, a role of which has been set to that of real-time cores, and allocating the non-real-time tasks to cores, a role of which has been set to that of non-real-time cores.

9. The task distribution method of claim 8, wherein the allocating the tasks to the set cores further comprises:
if the OS is not the real-time OS, or if the task information is not present, primarily allocating tasks to the non-real-time cores.

10. A task distribution apparatus for a multi-core system, comprising:
a multi-core unit including multiple cores for executing tasks;
an execution information collection unit for collecting task execution information while tasks allocated to the multiple cores are being executed by the multiple cores;
a core role setting unit for setting roles of the multiple cores included in the multi-core unit in such a way as to divide the cores into real-time cores for executing real-time tasks and non-real-time cores for executing non-real-time tasks, and adjusting the set roles of the cores based on the task execution information; and
a task allocation unit for allocating real-time tasks to cores, a role of which has been set to that of real-time cores, and allocating non-real-time tasks to cores, a role of which has been set to that of non-real-time cores, based on the set roles of the cores.

11. The task distribution apparatus of claim 10, wherein:
the execution information collection unit is configured to collect task execution procedure information including at least one of information about task execution times, information about a number and attributes of tasks that are executed, information about context switching, and information about cache misses, and
the core role setting unit is configured to, if the collected information meets a preset core imbalance condition, change the set roles of the cores based on the collected information.

12. The task distribution apparatus of claim 11, wherein the core role setting unit is configured to, if a difference between a requested task processing time and an actual task processing time falls outside a predetermined range based on the task execution time information, change a role of a predetermined number of non-real-time cores to that of real-time cores depending on the difference between the times.

13. The task distribution apparatus of claim 11, wherein the core role setting unit is configured to, if a difference between a ratio of non-real-time tasks to real-time tasks that are executed and a ratio of non-real-time cores to real-time cores, the roles of which have been set, falls outside a predetermined range, reset the roles of the cores so that the difference between the ratios is reduced.

14. The task distribution apparatus of claim 11, wherein the core role setting unit is configured to, if occurrence of the context switching increases to above a predetermined range, or if occurrence of the cache misses increases to above a predetermined range, change a role of a predetermined number of real-time cores to that of non-real-time cores.

15. The task distribution apparatus of claim 10, wherein the core role setting unit is configured to, if an Operating System (OS) of the multi-core system is a real-time OS and task information about tasks to be executed by the multi-core system is present, determine a number of real-time cores and a number of non-real-time cores so that the numbers are proportional to a number of real-time tasks and a number of non-real-time tasks, respectively, and set the roles of the cores of the multi-core system to a role of real-time cores and a role of non-real-time cores based on the determined numbers of the cores, wherein the real-time and non-real-time tasks are to be executed by the multi-core system.

16. The task distribution apparatus of claim 15, wherein the core role setting unit is configured to, if the OS is not the real-time OS, or if the task information is not present, set the roles of the cores so that a number of real-time cores is equal to a number of non-real-time cores.

17. The task distribution apparatus of claim 10, wherein the core role setting unit is configured to, if an OS of the multi-core system is a real-time OS, and task information about tasks to be executed by the multi-core system is present, allocate the real-time tasks to cores, a role of which has been set to that of real-time cores, and allocate the non-real-time tasks to cores, a role of which has been set to that of non-real-time cores.

18. The task distribution apparatus of claim 17, wherein the core role setting unit is configured to, if the OS is not the real-time OS, or if the task information is not present, primarily allocate tasks to the non-real-time cores.
